(19) United States
(12) Patent Application Publication
(10) Pub. No.: US 2024/0332548 A1
(43) Pub. Date: Oct. 3, 2024

(54) BATTERY

(71) Applicant: HONDA MOTOR CO., LTD., Tokyo (JP)

(72) Inventors: Kiyoshi Tanaami, Wako-shi (JP); Toshimitsu Tanaka, Wako-shi (JP)

(21) Appl. No.: 18/583,910

(22) Filed: Feb. 22, 2024

(30) Foreign Application Priority Data
Mar. 29, 2023 (CN) 202310324789.5

(51) Int. Cl. H01M 4/80; H01M 4/66; H01M 4/74; H01M 10/0525; H01M 10/0585

(52) U.S. Cl. CPC H01M 4/80; H01M 4/661; H01M 4/74; H01M 10/0525; H01M 10/0585

(57) ABSTRACT

Provided is a battery including: a positive electrode; a negative electrode; and an electrolyte layer, in which a laminate in which the negative electrode, the electrolyte layer, the positive electrode, the electrolyte layer, and the negative electrode are laminated in this order is regarded as a minimum unit, the positive electrode is composed of a first composite body consisting of a metal body and a positive electrode mixture containing a positive electrode active material, the negative electrode is composed of a second composite body consisting of a metal body and a negative electrode mixture containing a negative electrode active material, and the metal bodies are metallic porous bodies or metal meshes.

### CROSS-REFERENCE TO RELATED APPLICATION

Priority is claimed on Chinese Patent Application No. 202310324789.5, filed in China on Mar. 29, 2023, the content of which is incorporated herein by reference.

### BACKGROUND OF THE INVENTION

### Field of the Invention

The present invention relates to a battery.

### Description of Related Art

To ensure and maintain the performance as designed, batteries require press-molding under high surface pressure, a high bonding force, and subsequent maintenance of the bonded condition in a state where a laminate consisting of a positive electrode, an electrolyte layer, and a negative electrode is formed. As a method for manufacturing such a battery, for example, a method is known in which a sheet in which an electrode mixture is applied on both sides of a current-collecting foil and a solid electrolyte is placed on the upper surface of the electrode mixture is cut into an arbitrary shape to form a positive or negative electrode, and the resulting positive and negative electrodes are alternately laminated and press-molded to obtain a battery (for example, refer to Patent Document 1).

### PATENT DOCUMENTS

### [Patent Document 1]

Japanese Unexamined Patent Application, First Publication No. 2015-118870

### SUMMARY OF THE INVENTION

Positive or negative electrodes obtained by applying the electrode mixture to the current-collecting foil basically have the same materials, composition, and basis weight. Accordingly, the performance of a battery formed by laminating positive and negative electrodes depends on the design of the positive and negative electrodes. In particular, the energy density and the input/output density of a battery highly depend on the performance of the electrodes. On the other hand, the energy density and the input/output density of a battery contradict the design of electrodes. Accordingly, there is a problem that not only are the characteristics of a battery determined in advance at the time of designing electrodes, but also it is difficult to achieve both energy density and input/output density in the battery.

To solve the above-described problem, an object of the present application is to achieve both energy density and input/output density in a battery. Ultimately, it contributes to energy efficiency.

To achieve the above-described object, the present invention provides the following means.

[1] A battery including: a positive electrode; a negative electrode; and an electrolyte layer, in which a laminate in which the negative electrode, the electrolyte layer, the positive electrode, the electrolyte layer, and the negative electrode are laminated in this order is regarded as a minimum unit, the positive electrode is composed of a first composite body consisting of a metal body and a positive electrode mixture containing a positive electrode active material, the negative electrode is composed of a second composite body consisting of a metal body and a negative electrode mixture containing a negative electrode active material, and the metal bodies are metallic porous bodies or metal meshes.

In the battery of the present invention, the positive electrode is composed of a first composite body consisting of a metal body and a positive electrode mixture containing a positive electrode active material, the negative electrode is composed of a second composite body consisting of a metal body and a negative electrode mixture containing a negative electrode active material, and the metal bodies are metallic porous bodies or metal meshes, and therefore, it is possible to achieve both energy density and input/output density.

[2] A battery including: a positive electrode; a negative electrode; and an electrolyte layer, in which a laminate in which the negative electrode, the electrolyte layer, the positive electrode, the electrolyte layer, and the negative electrode are laminated in this order is regarded as a minimum unit, the positive electrode is composed of a first composite body consisting of a metal body and a positive electrode mixture containing a positive electrode active material, the negative electrode is composed of a second composite body consisting of a metal body and a negative electrode mixture containing a negative electrode active material, the first composite body has a first high capacity region and a first high output region along a thickness direction, the second composite body has a second high capacity region and a second high output region along the thickness direction, the laminate has a first portion in which the first high capacity region and the second high capacity region are laminated with the electrolyte layer interposed therebetween, and a second portion in which the first high output region and the second high output region are laminated with the electrolyte layer interposed therebetween, and the metal bodies are metallic porous bodies or metal meshes.

In the battery of the present invention, the positive electrode is composed of a first composite body consisting of a metal body and a positive electrode mixture containing a positive electrode active material, the negative electrode is composed of a second composite body consisting of a metal body and a negative electrode mixture containing a negative electrode active material, the first composite body has a first high capacity region and a first high output region along a thickness direction, the second composite body has a second high capacity region and a second high output region along the thickness direction, the laminate has a first portion in which the first high capacity region and the second high capacity region are laminated with the electrolyte layer interposed therebetween, and a second portion in which the first high output region and the second high output region are laminated with the electrolyte layer interposed therebetween, and the metal bodies are metallic porous bodies or metal meshes, and therefore, it is possible to achieve both energy density and input/output density.

[3] A battery including: a positive electrode; a negative electrode; and an electrolyte layer, in which a laminate in which the negative electrode, the electrolyte layer, the positive electrode, the electrolyte layer, and the negative electrode are laminated in this order is regarded as a minimum unit, the positive electrode is composed of a composite body consisting of a positive electrode mixture containing a positive electrode active material and a metal body composed of a metallic porous body or a metal mesh, and the composite body has a high capacity region along a thickness direction and a high output region along a thickness direction, the negative electrode includes the metal body, and the metal body in the negative electrode has a filled region filled with a negative electrode mixture containing a negative electrode active material and a non-filled region not filled with the negative electrode mixture, and the laminate has a first portion in which the high capacity region and the non-filled region are laminated with the electrolyte layer interposed therebetween, and a second portion in which the high output region and the filled region are laminated with the electrolyte layer interposed therebetween.

In the battery of the present invention, the positive electrode is composed of a composite body consisting of a positive electrode mixture containing a positive electrode active material and a metal body composed of a metallic porous body or a metal mesh, and the composite body has a high capacity region along a thickness direction and a high output region along a thickness direction, the negative electrode includes the metal body, and the metal body in the negative electrode has a filled region filled with a negative electrode mixture containing a negative electrode active material and a non-filled region not filled with the negative electrode mixture, and the laminate has a first portion in which the high capacity region and the non-filled region are laminated with the electrolyte layer interposed therebetween, and a second portion in which the high output region and the filled region are laminated with the electrolyte layer interposed therebetween, and therefore, it is possible to achieve both energy density and input/output density.

[4] The batteries according to any one of [1] to [3], which are all-solid batteries.

The batteries of the present invention are all-solid batteries, and since the batteries include the configuration according to the present invention, it is possible to achieve both energy density and input/output density.

According to the present invention, it is possible to achieve both energy density and input/output density in the batteries.

### BRIEF DESCRIPTION OF THE DRAWINGS

FIG. 1 is a cross-sectional view showing a first embodiment of a battery according to an embodiment of the present invention.

FIG. 2 is a cross-sectional view showing a second embodiment of a battery according to an embodiment of the present invention.

### DETAILED DESCRIPTION OF THE INVENTION

Hereinafter, embodiments of the present invention will be described.

### [Battery]

### First Embodiment

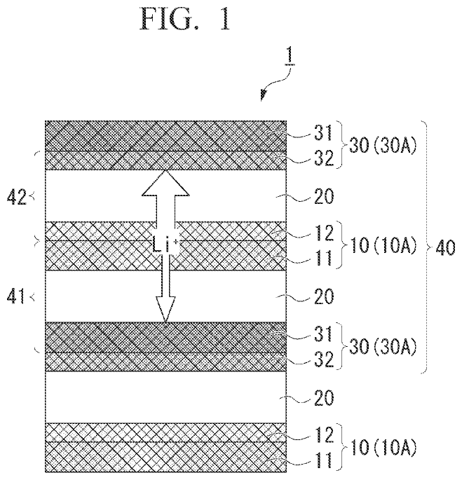

FIG. 1 is a cross-sectional view showing a first embodiment of a battery according to an embodiment of the present invention. In the drawings used in the following description, a part that becomes a feature is sometimes enlarged for convenience in order to allow the feature to be easily understood, and the dimensional ratios of each constituent element or the like are not limited to those shown in the drawings.

A battery 1 includes a positive electrode 10, an electrolyte layer 20, and a negative electrode 30. In the battery 1, a laminate 40 in which the negative electrode 30, the electrolyte layer 20, the positive electrode 10, the electrolyte layer 20, and the negative electrode 30 are laminated in this order is regarded as a minimum unit. That is, the battery 1 may include only one laminate 40, or may include two or more laminates 40. In a case where two or more laminates 40 are included, two or more laminates 40 are laminated such that the negative electrode 30, the electrolyte layer 20, the positive electrode 10, the electrolyte layer 20, and the negative electrode 30 are laminated in this order. As shown in FIG. 1, one laminate 40 and another laminate 40 laminated thereon may share the negative electrode 30. The battery 1 is preferably an all-solid battery.

The positive electrode 10 is composed of a first composite body 10A consisting of a metal body and a positive electrode mixture containing a positive electrode active material.

The first composite body 10A has a first high capacity region 11 and a first high output region 12 along the thickness direction.

The negative electrode 30 is composed of a second composite body 30A consisting of a metal body and a negative electrode mixture containing a negative electrode active material.

The second composite body 30A has a second high capacity region 31 and a second high output region 32 along the thickness direction.

The laminate 40 has a first portion 41 in which the first high capacity region 11 and the second high capacity region 31 are laminated with the electrolyte layer 20 interposed therebetween, and a second portion 42 in which the first high output region 12 and the second high output region 32 are laminated with the electrolyte layer 20 interposed therebetween.

### (Positive Electrode)

The positive electrode mixture contained in the positive electrode 10 contains a positive electrode active material that gives and receives lithium ions and electrons. The positive electrode active material is not particularly limited as long as it is a material that can reversibly release and absorb lithium ions and can transport electrons, and any well-known positive electrode active material that can be used as a positive electrode of an all-solid-state lithium ion battery can be used. Examples thereof include: complex oxides, such as lithium cobalt oxide (LiCoO₂), lithium nickel oxide (LiNiO₂), lithium manganese oxide (LiMn₂O₄), solid solution oxide (Li₂MnO₃—LiMO₂ (M=Co, Ni, etc.)), lithium-manganese-nickel-cobalt oxide (LiNiₓMn_{y}Co_{z}O₂, x+y+z=1), and olivine type lithium phosphorus oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; and a mixture of sulfur and carbon. The positive electrode active material may be composed of one kind of the above-described materials or two or more kinds thereof.

The positive electrode mixture may contain a conductive assistant from the viewpoint of improving the conductivity of the positive electrode 10. As the conductive assistant, a conductive assistant that can be generally used in an all-solid-state lithium ion battery can be used. Examples thereof include carbon black such as acetylene black and Ketjen black; vapor grown carbon fiber; graphite powder; and carbon materials such as a carbon nanotube. The conductive assistant may be composed of one kind of the above-described materials or two or more kinds thereof.

In addition, the positive electrode mixture may contain a binder that serves to bind positive electrode active material and bind a positive electrode active material to a metal body.

The metal body is a metallic porous body or a metal mesh. Since the metal body is a metallic porous body or a metal mesh, the positive electrode mixture can be held within the metal body.

The metallic porous body is a metallic porous body containing many pores like a resin sponge. Examples of metal materials of metallic porous bodies include foamed aluminum produced by adding a foaming agent to molten metal.

The metal mesh is a material obtained by knitting a produced wire like cloth. Examples of metal materials for the metal mesh include stainless steel, aluminum, copper, silver, gold, and platinum.

The first high capacity region 11 differs from the first high output region 12 in the basis weight and composition of the positive electrode mixture contained in the metal body.

The first high capacity region 11 is a region in which the basis weight and composition of the positive electrode mixture contained in the metal body are adjusted to increase the energy density.

The first high output region 12 is a region in which the basis weight and composition of the positive electrode mixture contained in the metal body are adjusted to increase the input/output density.

### (Electrolyte Layer)

A solid electrolyte constituting the electrolyte layer 20 is not particularly limited as long as it has lithium ion conductivity and insulation properties, and materials generally used in all-solid-state lithium ion batteries can be used. Examples thereof include: inorganic solid electrolytes such as a sulfide solid electrolyte material, an oxide solid electrolyte materials, a halide solid electrolyte, and lithium-containing salts; polymer-based solid electrolytes such as polyethylene oxide; and gel-based solid electrolytes containing a lithium ion conductive ionic liquid. Among these, sulfide solid electrolyte materials are preferable from the viewpoints of high conductivity of lithium ions, favorable structural moldability by pressing, and favorable interfacial bondability.

The form of a solid electrolyte material is not particularly limited, but examples thereof include particulates.

The electrolyte layer 20 may contain a well-known non-aqueous electrolyte in lithium ion secondary batteries, electric double-layer capacitors, and the like.

The electrolyte layer 20 may contain an adhesive for imparting mechanical strength or flexibility.

The electrolyte layer 20 may be in the form of a sheet having a porous base material and a solid electrolyte held by the porous base material. The form of the above-described porous base material is not particularly limited, and examples thereof include woven fabrics, non-woven fabrics, mesh cloth, porous films, expanded sheets, and punched sheets. Among these forms, non-woven fabrics are preferable from the viewpoint of handling properties that allow the amount of solid electrolyte filled to be further increased.

The above-described porous base material is preferably made of an insulating material. Accordingly, the insulation properties of the electrolyte layer 20 can be improved. Examples of insulating materials include: resin materials such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethanes, vinylon, polybenzimidazole, polyimides, polyphenylene sulfite, polyether ether ketone, cellulose, and acrylic resins; natural fibers such as hemp, wood pulp, and cotton linters; and glass.

### (Negative Electrode)

The negative electrode mixture contained in the negative electrode 30 contains a negative electrode active material that gives and receives lithium ions and electrons. The negative electrode active material is not particularly limited as long as it is a material that can reversibly release and absorb lithium ions and can transport electrons, and any well-known negative electrode active material that can be used as a negative electrode of an all-solid-state lithium ion battery can be used. Examples thereof include carbonaceous materials such as natural graphite, artificial graphite, resinous coal, carbon fibers, activated coal, hard carbon, and soft carbon; alloy-type materials mainly composed of tin, tin alloy, silicon, silicon alloy, gallium, gallium alloy, indium, indium alloy, aluminum, aluminum alloy, and the like; conductive polymers such as polyacene, polyacetylene, and polypyrrole; metallic lithium and lithium alloys; and lithium-titanium composite oxides (for example, Li₄Ti₅O₁₂). These negative electrode active materials may be composed of one kind of the above-described materials or two or more kinds thereof.

The negative electrode mixture may contain a conductive assistant, a binder, and the like. These materials are not particularly limited, but for example, materials similar to those used in the above-described positive electrode mixture can be used.

Materials similar to those used in the above-described positive electrode mixture can be used in the metal body.

The second high capacity region 31 differs from the second high output region 32 in the basis weight and composition of the negative electrode mixture contained in the metal body.

The second high capacity region 31 is a region in which the basis weight and composition of the negative electrode mixture contained in the metal body are adjusted to increase the energy density.

The second high output region 32 is a region in which the basis weight and composition of the negative electrode mixture contained in the metal body are adjusted to increase the input/output density.

According to the battery 1 of the present embodiment, the positive electrode 10 is composed of a first composite body 10A consisting of a positive electrode mixture and a metal body composed of a metallic porous body or a metal mesh, the negative electrode 30 is composed of a second composite body 30A consisting of a negative electrode mixture and a metal body composed of a metallic porous body or a metal mesh, the first composite body 10A has a first high capacity region 11 and a first high output region 12 along the thickness direction, the second composite body 30A has a second high capacity region 31 and a second high output region 32 along the thickness direction, and the laminate 40 has a first portion 41 in which the first high capacity region 11 and the second high capacity region 31 are laminated with the electrolyte layer 20 interposed therebetween, and a second portion 42 in which the first high output region 12 and the second high output region 32 are laminated with the electrolyte layer 20 interposed therebetween, and therefore, the input/output density also can be improved while improving the energy density.

### Second Embodiment

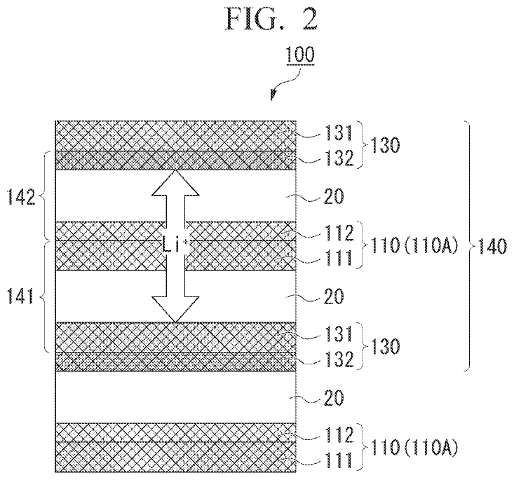

FIG. 2 is a cross-sectional view showing a second embodiment of a battery according to an embodiment of the present invention.

A battery 100 includes a positive electrode 110, an electrolyte layer 20, and a negative electrode 130. In the battery 100, a laminate 140 in which the negative electrode 130, the electrolyte layer 20, the positive electrode 110, the electrolyte layer 20, and the negative electrode 130 are laminated in this order is regarded as a minimum unit. That is, the battery 100 may include only one laminate 140, or may include two or more laminates 140. In a case where two or more laminates 140 are included, two or more laminates 140 are laminated such that the negative electrode 130, the electrolyte layer 20, the positive electrode 110, the electrolyte layer 20, and the negative electrode 130 are laminated in this order. As shown in FIG. 2, one laminate 140 and another laminate 140 laminated thereon may share the negative electrode 130. The battery 100 is preferably an all-solid battery.

The positive electrode 110 is composed of a composite body 110A consisting of a positive electrode mixture containing a positive electrode active material and a metal body composed of a metallic porous body or a metal mesh.

The composite body 110A has a high capacity region 111 along the thickness direction and a high output region 112 along the thickness direction.

The negative electrode 130 contains a metal body composed of a metallic porous body or a metal mesh. The metal body has a filled region 132 filled with a negative electrode mixture containing a negative electrode active material and a non-filled region 131 not filled with the negative electrode mixture.

The laminate 140 has a first portion 141 in which the high capacity region 111 and the non-filled region 131 are laminated with the electrolyte layer 20 interposed therebetween, and a second portion 142 in which the high output region 112 and the filled region 132 are laminated with the electrolyte layer 20 interposed therebetween.

As the positive electrode mixture, negative electrode mixture, and metal body, materials similar to those in the first embodiment can be used.

According to the battery 100 of the present embodiment, the positive electrode 110 is composed of a composite body 110A consisting of a positive electrode mixture and a metal body composed of a metallic porous body or a metal mesh, the composite body 110A has a high capacity region 111 along the thickness direction and a high output region 112 along the thickness direction, the negative electrode 130 includes the metal body, and the metal body in the negative electrode has a filled region 132 filled with a negative electrode mixture and a non-filled region 131 not filled with the negative electrode mixture, and the laminate 140 has a first portion 141 in which the high capacity region 111 and the non-filled region 131 are laminated with the electrolyte layer 20 interposed therebetween, and a second portion 142 in which the high output region 112 and the filled region 132 are laminated with the electrolyte layer 20 interposed therebetween, and therefore, the input/output density also can be improved while improving the energy density. When metallic lithium is used as the negative electrode active material in the battery 100 of present embodiment, it is also possible to achieve anode-free, in which lithium transferred from the positive electrode 110 is deposited in the negative electrode 130 during charging, without filling the metal body composed of a metallic porous body or a metal mesh in the negative electrode 130 with anything. Accordingly, the energy density of the battery 100 can also be improved.

Although the embodiments of the present invention have been described in detail above, the present invention is not limited to the above-described embodiments and various modifications and changes can be made within the scope of the gist of the present invention disclosed in the claims.

### EXPLANATION OF REFERENCES

1, 100 Battery
10, 110 Positive electrode
10A First composite body
11 First high capacity region
12 First high output region
20 Electrolyte layer
30, 130 Negative electrode
30A Second composite body
31 Second high capacity region
32 Second high output region
40, 140 Laminate
41, 141 First portion
42, 142 Second portion
110A Composite body
111 High capacity region
112 High output region
131 Non-filled region
132 Filled region

What is claimed is:

1. A battery comprising:
a positive electrode;
a negative electrode; and
an electrolyte layer,
wherein a laminate in which the negative electrode, the electrolyte layer, the positive electrode, the electrolyte layer, and the negative electrode are laminated in this order is regarded as a minimum unit,
wherein the positive electrode is composed of a first composite body consisting of a metal body and a positive electrode mixture containing a positive electrode active material,
wherein the negative electrode is composed of a second composite body consisting of a metal body and a negative electrode mixture containing a negative electrode active material, and
wherein the metal bodies are metallic porous bodies or metal meshes.

2. A battery comprising:
a positive electrode;
a negative electrode; and
an electrolyte layer,
wherein a laminate in which the negative electrode, the electrolyte layer, the positive electrode, the electrolyte layer, and the negative electrode are laminated in this order is regarded as a minimum unit,
wherein the positive electrode is composed of a first composite body consisting of a metal body and a positive electrode mixture containing a positive electrode active material,
wherein the negative electrode is composed of a second composite body consisting of a metal body and a negative electrode mixture containing a negative electrode active material,
wherein the first composite body has a first high capacity region and a first high output region along a thickness direction,
wherein the second composite body has a second high capacity region and a second high output region along the thickness direction,
wherein the laminate has a first portion in which the first high capacity region and the second high capacity region are laminated with the electrolyte layer interposed therebetween, and a second portion in which the first high output region and the second high output region are laminated with the electrolyte layer interposed therebetween, and
wherein the metal bodies are metallic porous bodies or metal meshes.

3. A battery comprising:
a positive electrode;
a negative electrode; and
an electrolyte layer,
wherein a laminate in which the negative electrode, the electrolyte layer, the positive electrode, the electrolyte layer, and the negative electrode are laminated in this order is regarded as a minimum unit,
wherein the positive electrode is composed of a composite body consisting of a positive electrode mixture containing a positive electrode active material and a metal body composed of a metallic porous body or a metal mesh, and the composite body has a high capacity region along a thickness direction and a high output region along a thickness direction,
wherein the negative electrode includes the metal body, and the metal body in the negative electrode has a filled region filled with a negative electrode mixture containing a negative electrode active material and a non-filled region not filled with the negative electrode mixture, and
wherein the laminate has a first portion in which the high capacity region and the non-filled region are laminated with the electrolyte layer interposed therebetween, and a second portion in which the high output region and the filled region are laminated with the electrolyte layer interposed therebetween.

4. The batteries according to claim 1, which are all-solid batteries.

5. The batteries according to claim 2, which are all-solid batteries.

6. The batteries according to claim 3, which are all-solid batteries.
